(19) United States
(12) Patent Application Publication
(10) Pub. No.: US 2026/0244988 A1
(43) Pub. Date: Aug. 20, 2026

(54) COMPUTING DEVICE FOR PERFORMING LEARNING OF ARTIFICIAL INTELLIGENCE MODEL AND METHOD OF LEARNING ARTIFICIAL INTELLIGENCE MODEL OF COMPUTING DEVICE

(71) Applicant: AJOU UNIVERSITY INDUSTRY-ACADEMIC COOPERATION FOUNDATION, SUWON-SI (KR)

(72) Inventors: Jung Won LEE, Seoul (KR); Jin Se KIM, Suwon-si (KR)

(73) Assignee: AJOU UNIVERSITY INDUSTRY-ACADEMIC COOPERATION FOUNDATION, SUWON-SI (KR)

(21) Appl. No.: 19/376,724

(22) Filed: Oct. 31, 2025

(30) Foreign Application Priority Data
Feb. 17, 2025 (KR) 10-2025-0020110

(51) Int. Cl. G06N 20/00; G06F 18/24

(52) U.S. Cl. CPC G06N 20/00; G06F 18/24

(57) ABSTRACT

A method of training an artificial intelligence model of a computing device according to an embodiment of the present disclosure, includes training an artificial intelligence model on learning data, extracting flattened data output from a flattening layer of the artificial intelligence model as learning feature data, classifying the learning feature data into a plurality of cluster data based on a result of clustering the learning feature data, determining first cluster data of first class data and second cluster data of second class data, the first cluster data and the second cluster data including data of a class overlap region, based on a result of quantifying similarity between the plurality of cluster data, processing the class overlap on the first cluster data based on an amount of the second class data, and retraining the artificial intelligence model.

### CROSS-REFERENCE TO RELATED APPLICATION

The present application claims priority under 35 U.S.C. § 119(a) to Korean patent application number 10-2025-0020110 filed on February 17, 2025, in the Korean Intellectual Property Office, the entire disclosure of which is incorporated by reference herein.

### BACKGROUND

### Technical Field

The present disclosure relates to a computing device for training an artificial intelligence model and a method of training the artificial intelligence model of the computing device.

### Related Art

The sensitivity, which is one of the indicators for evaluating performance of the artificial intelligence model, may be importantly considered in high-risk domains where misclassification of data may have a large impact or in critical domains where an important decision is required or a high level of risk is involved. If the sensitivity of the artificial intelligence model is low, data corresponding to a fault state of an industrial facility may be classified as a normal state, or data corresponding to a disease state of a human may be classified as a health state. Accordingly, in high-risk or critical domains, an artificial intelligence model having high sensitivity may be required.

### SUMMARY

Embodiments relate to a computing device for training to improve sensitivity of an artificial intelligence model and a method thereof.

According to an embodiment, a method of training an artificial intelligence model of a computing device, includes training an artificial intelligence model on learning data, extracting flattened data output from a flattening layer of the artificial intelligence model as learning feature data, classifying the learning feature data into a plurality of cluster data based on a result of clustering the learning feature data, determining first cluster data of first class data and second cluster data of second class data, the first cluster data and the second cluster data including data of a class overlap region, based on a result of quantifying similarity between the plurality of cluster data, processing the class overlap on the first cluster data based on an amount of the second class data, and retraining the artificial intelligence model.

According to an embodiment, a computing device includes an artificial intelligence model configured to be trained based on learning data, and a processor configured to extract flattened data output from a flattening layer of the artificial intelligence model as learning feature data, classify the learning feature data into a plurality of cluster data based on a result of clustering the learning feature data, determine first cluster data of first class data and second cluster data of second class data, the first cluster data and the second cluster data including data of a class overlap region, based on a result of quantifying similarity between the plurality of cluster data, process the class overlap on the first cluster data based on an amount of the second class data, and retraining the artificial intelligence model based on a result of processing the class overlap.

According to embodiments, a computing device for training to improve sensitivity of an artificial intelligence model and a method thereof are provided.

### BRIEF DESCRIPTION OF THE DRAWINGS

FIG. 1 illustrates a computing device according to an embodiment.

FIG. 2 illustrates an artificial intelligence model according to an embodiment.

FIG. 3 illustrates a computing device for clustering flattened data according to an embodiment.

FIG. 4 illustrates a computing device for quantifying similarity between cluster data according to an embodiment.

FIG. 5 illustrates a computing device for determining cluster data of a class overlap region according to an embodiment.

FIG. 6 illustrates a computing device for removing cluster data according to an embodiment.

FIG. 7 illustrates a computing device for redefining a class of cluster data according to an embodiment.

FIG. 8 is a flowchart illustrating a computing device for determining cluster data of a class overlap region according to an embodiment.

FIG. 9 is a flowchart illustrating a computing device for readjusting cluster data of a class overlap region according to an embodiment.

### DETAILED DESCRIPTION

Hereinafter, various embodiments will be described in detail with reference to the accompanying drawings so that those skilled in the art can readily practice the present disclosure. The present disclosure may be embodied in many different forms and is not limited to the embodiments set forth herein.

For clarity of description of the present disclosure, parts unrelated to the description are omitted, and throughout the specification, the same reference numerals are used to denote the same or similar elements.

In addition, throughout the specification, when a part is described as “comprising” a component, it does not exclude other components unless specifically stated otherwise, but rather means that other components may be further included.

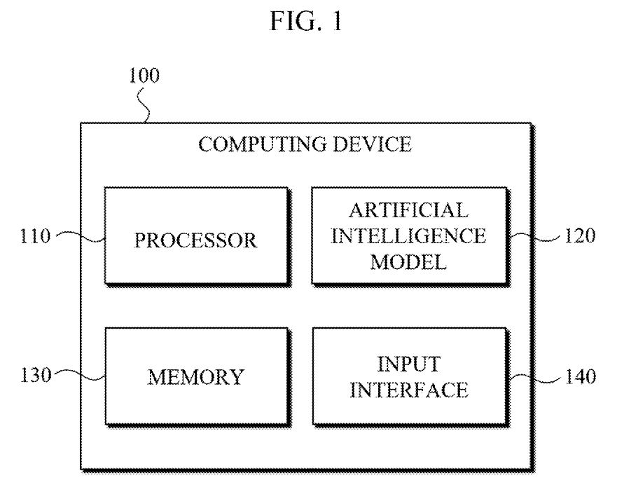

FIG. 1 illustrates a computing device according to an embodiment.

Referring to FIG. 1, the computing device 100 may include a processor 110, an artificial intelligence model 120, a memory 130, and an input interface 140.

In an embodiment, the processor 110 may control overall operations of the computing device 100.

In an embodiment, the artificial intelligence model 120 may be a model trained based on learning data. In an embodiment, the artificial intelligence model 120 may be a convolutional neural network (CNN) model. In an embodiment, the artificial intelligence model 120 may classify input data into classes according to trained data and output output data corresponding to a result of the classification.

In an embodiment, the memory 130 may store data generated by the computing device 100. In an embodiment, the memory 130 may store learning data used for training the artificial intelligence model 120. In an embodiment, the memory 130 may store output data output by the artificial intelligence model 120. In an embodiment, the memory 130 may store input data input to the trained artificial intelligence model 120.

In an embodiment, the input interface 140 may receive an input of a user of the computing device. In an embodiment, the input interface 140 may be a keyboard, a mouse, or the like.

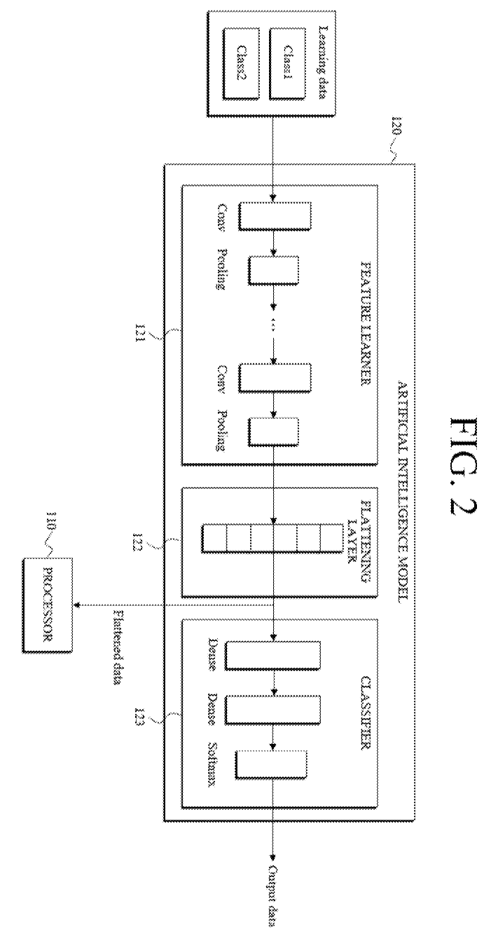

FIG. 2 illustrates an artificial intelligence model according to an embodiment.

Referring to FIG. 2, the artificial intelligence model 120 may perform learning based on learning data. In an embodiment, the learning data may be data related to diagnosis of defects of industrial facilities. In an embodiment, the learning data may be data related to diagnosis of diseases of humans.

In an embodiment, the learning data may include first class data Class1 and second class data Class2. In an embodiment, when the learning data is related to the defect diagnosis of industrial facilities, the first class data Class1 may be data indicating that the industrial facility is in a normal state, and the second class data Class2 may be data indicating that the industrial facility is in a fault state.

In an embodiment, when the learning data is related to the disease diagnosis of humans, the first class data Class1 may be data indicating a health state, and the second class data Class2 may be data indicating a disease state.

In an embodiment, the artificial intelligence model 120 may include a feature learner 121, a flattening layer 122, and a classifier 123.

In an embodiment, the feature learner 121 may generate data related to features of the learning data. In an embodiment, the feature learner 121 may perform convolution (Conv) and pooling (Pooling) on the learning data a plurality of times. In an embodiment, the feature learner 121 may provide, to the flattening layer 122, the data obtained by performing convolution (Conv) and pooling (Pooling) on the learning data a plurality of times.

In an embodiment, the flattening layer 122 may convert multidimensional data received from the feature learner 121 into one-dimensional data. In an embodiment, the flattening layer 122 may generate flattened data by flattening the data received from the feature learner 121 and may provide the flattened data to the classifier 123 and the processor 110. In an embodiment, the flattened data may be data related to learning features of the learning data. In an embodiment, the flattened data may be data directly associated with a class classification result represented by output data output from the classifier 123. In an embodiment, the output data may be determined according to the learning features of the learning data represented by the flattened data.

In an embodiment, the processor 110 may extract flattened data received from the flattening layer 122 as learning feature data related to features of the learning data.

In an embodiment, the classifier 123 may compute the flattened data with weight values through a dense layer (Dense) and may normalize the computed values through a softmax (Softmax) function to output output data corresponding to the classification result of the learning data.

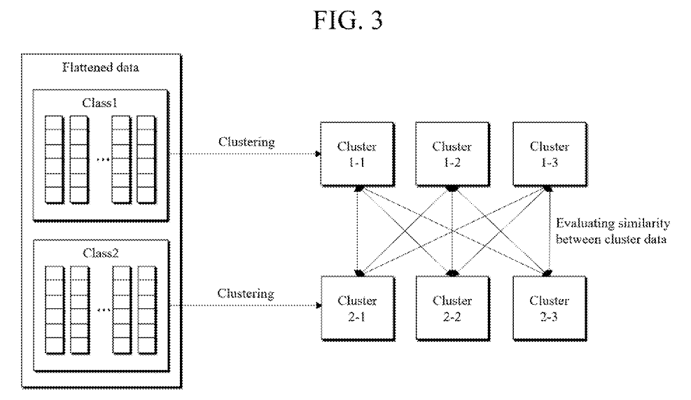

FIG. 3 illustrates a computing device for clustering flattened data according to an embodiment.

Referring to FIG. 3, the processor 110 may extract flattened data received from the flattening layer 122 as learning feature data. In an embodiment, the flattened data may include first class data Class1 and second class data Class2.

In an embodiment, the processor 110 may perform data domain partitioning based on clustering of flattened data. In an embodiment, the processor 110 may perform data domain partitioning on the flattened data using distance-based clustering. In an embodiment, the distance-based clustering may be K-means clustering.

In an embodiment, the processor 110 may generate a plurality of cluster data based on a result of clustering the flattened data. In an embodiment, the processor 110 may generate first-1 cluster data Cluster1-1, first-2 cluster data Cluster1-2, and first-3 cluster data Cluster1-3 based on a result of clustering the first class data Class1. In an embodiment, the processor 110 may generate second-1 cluster data Cluster2-1, second-2 cluster data Cluster2-2, and second-3 cluster data Cluster2-3 based on a result of clustering the second class data Class2.

In an embodiment, the processor 110 may evaluate similarity between the plurality of cluster data. In an embodiment, the processor 110 may determine cluster data in a class overlap region among the plurality of cluster data through evaluating similarity between the plurality of cluster data. In an embodiment, the class overlap region may be a region on a data domain that includes cluster data respectively belonging to different classes. In an embodiment, the class overlap region may include one of first-1 cluster data Cluster1-1, first-2 cluster data Cluster1-2, and first-3 cluster data Cluster1-3 of the first class, and one of second-1 cluster data Cluster2-1, second-2 cluster data Cluster2-2, and second-3 cluster data Cluster2-3 of the second class.

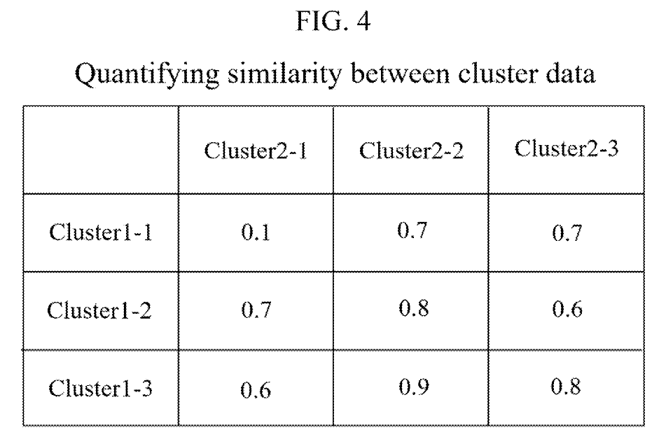

FIG. 4 illustrates a computing device for quantifying similarity between cluster data according to an embodiment.

Referring to FIG. 4, the processor 110 may evaluate and quantify similarity between a plurality of cluster data. In an embodiment, the processor 110 may quantify similarity between the plurality of cluster data using a silhouette coefficient, a Davies–Bouldin index, a Dunn index, and the like. FIG. 4 exemplarily illustrates a case of using the silhouette coefficient.

In an embodiment, the processor 110 may determine values representing similarity between the plurality of cluster data using the silhouette coefficient. In an embodiment, when using the silhouette coefficient, the values representing similarity may be determined to be between -1 and 1. In an embodiment, the greater the value representing similarity is, the lower the similarity between the plurality of cluster data may be. In an embodiment, the smaller the value representing similarity is, the higher the similarity between the plurality of cluster data may be.

In an embodiment, the processor 110 may determine a value representing similarity between the first-1 cluster data Cluster1-1 and the second-1 cluster data Cluster2-1 as 0.1. In an embodiment, the processor 110 may determine a value representing similarity between the first-1 cluster data Cluster1-1 and the second-2 cluster data Cluster2-2 as 0.7. In an embodiment, the processor 110 may determine a value representing similarity between the first-1 cluster data Cluster1-1 and the second-3 cluster data Cluster2-3 as 0.7.

In an embodiment, the processor 110 may determine a value representing similarity between the first-2 cluster data Cluster1-2 and the second-1 cluster data Cluster2-1 as 0.7. In an embodiment, the processor 110 may determine a value representing similarity between the first-2 cluster data Cluster1-2 and the second-2 cluster data Cluster2-2 as 0.8. In an embodiment, the processor 110 may determine a value representing similarity between the first-2 cluster data Cluster1-2 and the second-3 cluster data Cluster2-3 as 0.6.

In an embodiment, the processor 110 may determine a value representing similarity between the first-3 cluster data Cluster1-3 and the second-1 cluster data Cluster2-1 as 0.6. In an embodiment, the processor 110 may determine a value representing similarity between the first-3 cluster data Cluster1-3 and the second-2 cluster data Cluster2-2 as 0.9. In an embodiment, the processor 110 may determine a value representing similarity between the first-3 cluster data Cluster1-3 and the second-3 cluster data Cluster2-3 as 0.8.

In an embodiment, the processor 110 may determine cluster data of a class overlap region based on values representing similarity between the plurality of cluster data. In an embodiment, the processor 110 may determine the first-1 cluster data Cluster1-1 and the second-1 cluster data Cluster2-1, which are associated with the smallest value of 0.1 among the values representing similarity between the plurality of cluster data, as cluster data of the class overlap region.

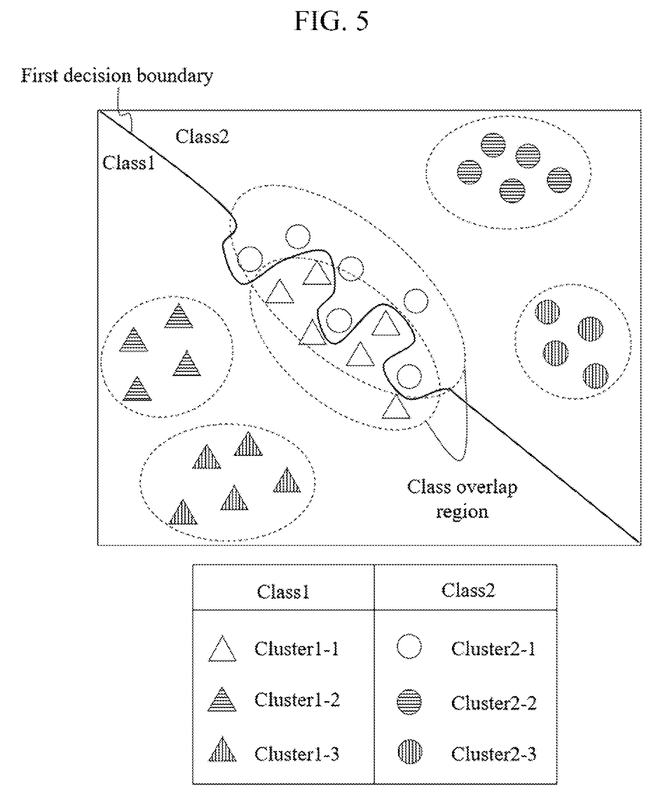

FIG. 5 illustrates a computing device for determining cluster data of a class overlap region according to an embodiment.

Referring to FIG. 5, the processor 110 may derive a result of quantifying similarity between a plurality of cluster data on a data domain. In an embodiment, the processor 110 may determine a first decision boundary that distinguishes the first-1 cluster data Cluster1-1 of the first class data and the second-1 cluster data Cluster2-1 of the second class data based on a result of quantifying similarity between the plurality of cluster data.

In an embodiment, as described with reference to FIG. 4, when a value representing similarity between the first-1 cluster data Cluster1-1 and the second-1 cluster data Cluster2-1 is the smallest among values representing similarity between the plurality of cluster data, the first-1 cluster data Cluster1-1 and the second-1 cluster data Cluster2-1 may be positioned adjacent to the first decision boundary on the data domain.

In an embodiment, the processor 110 may determine the first-1 cluster data Cluster1-1 and the second-1 cluster data Cluster2-1, which include data of a class overlap region among the plurality of cluster data, based on a result of quantifying similarity between the plurality of cluster data. In an embodiment, the class overlap region may be a region including cluster data positioned adjacent to a first decision boundary.

In an embodiment, even when a decision boundary is determined as illustrated by the first decision boundary shown in FIG. 5, if a large number of data to be classified are focused on a specific class, the artificial intelligence model may classify a small number of data of a class overlap region into the class on which the large number of data are focused in order to increase accuracy, which may result in a decrease in sensitivity.

In an embodiment, when the sensitivity of the artificial intelligence model 120 is low, the artificial intelligence model 120 may classify data indicating a defect of an industrial facility or a disease of a human as data indicating a normal state or health state, which may cause fatal problems such as an accident resulting from the defect of the industrial facility or a missed opportunity for timely treatment of a patient.

In an embodiment, the processor 110 may process a class overlap to readjust cluster data of a class overlap region in order to improve sensitivity of the artificial intelligence model 120. In an embodiment, when first class data is data indicating a normal state or a health state and second class data is data indicating a defect state or a disease state, if the second-1 cluster data Cluster2-1 is classified into the first class instead of the second class, sensitivity of the artificial intelligence model 120 may decrease. Accordingly, to prevent this, a class of the first-1 cluster data Cluster1-1 may be readjusted.

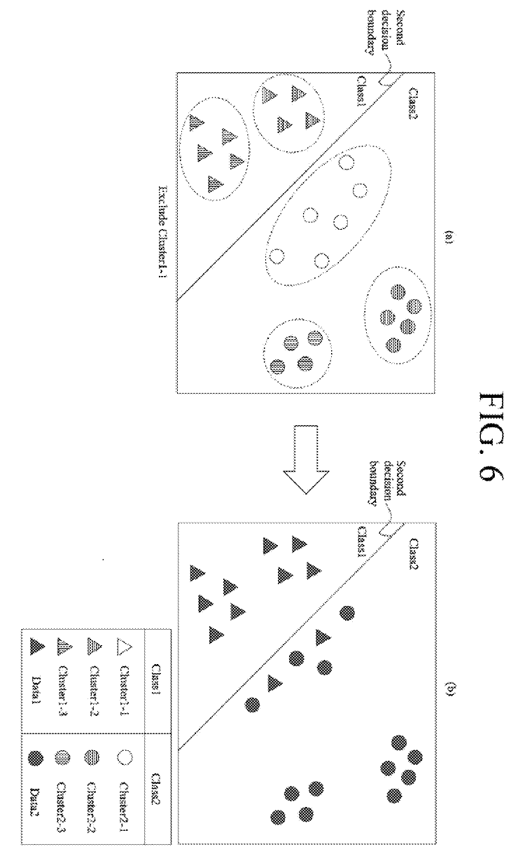

FIG. 6 illustrates a computing device for removing cluster data according to an embodiment.

Referring to FIG. 6, the processor 110 may exclude the first-1 cluster data Cluster1-1 from learning data in order to improve sensitivity of the artificial intelligence model 120. In an embodiment, when an amount of the second class data Class2 is greater than a preset amount, the processor 110 may process the class overlap by excluding the first-1 cluster data Cluster1-1 from the learning data. In an embodiment, when a difference in amount between the first class data Class1 and the second class data Class2 is smaller than a preset amount, such that data imbalance between the first class data Class1 and the second class data Class2 is not severe, the processor 110 may exclude the first-1 cluster data Cluster1-1 from the learning data.

In an embodiment, referring to part (a) of FIG. 6, the processor 110 may exclude the first-1 cluster data Cluster1-1 from learning data and then reconstruct a learning dataset. In an embodiment, the processor 110 may control the artificial intelligence model 120 to retrain based on the first-2 cluster data Cluster1-2 and the first-3 cluster data Cluster1-3, which correspond to remaining cluster data of the first class data Class1 excluding the first-1 cluster data Cluster1-1, and the second-1 cluster data Cluster2-1, the second-2 cluster data Cluster2-2, and the second-3 cluster data Cluster2-3, which correspond to the second class data Class2. In an embodiment, after retraining, the artificial intelligence model 120 may determine a second decision boundary that distinguishes the remaining cluster data of the first class data Class1 excluding the first-1 cluster data Cluster1-1 and the second class data Class2 as a decision boundary.

In an embodiment, referring to part (b) of FIG. 6, when first data Data1 and second data Data2 are received as input data, the artificial intelligence model 120 retrained based on the remaining cluster data of the first class data Class1 excluding the first-1 cluster data Cluster1-1 and the second class data Class2 may classify the first data Data1 and the second data Data2 according to the second decision boundary. In an embodiment, the first data Data1 may be data indicating a normal state of an industrial facility or a health state of a human, and the second data Data2 may be data indicating a defect state of an industrial facility or a disease state of a human.

In an embodiment, the retrained artificial intelligence model 120 may classify the second data Data2 into the second class according to the second decision boundary, classify a large number of the first data Data1 into the first class, and classify a small number of the first data Data1 into the second class. In an embodiment, the retrained artificial intelligence model 120 may have higher sensitivity than the artificial intelligence model trained based on the learning data by classifying the second data Data2 corresponding to data indicating a defect state of an industrial facility or a disease state of a human into the second class data Class2 according to the second decision boundary, instead of classifying it into the first class data Class1 indicating a normal state or a health state.

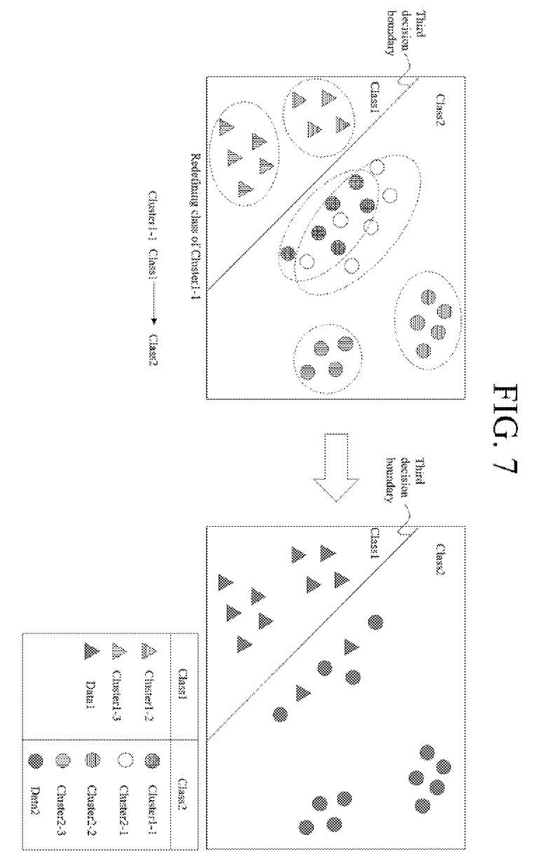

FIG. 7 illustrates a computing device for redefining a class of cluster data according to an embodiment.

Referring to FIG. 7, the processor 110 may redefine a class of the first-1 cluster data Cluster1-1 in order to improve sensitivity of the artificial intelligence model 120.

In an embodiment, when an amount of the second class data Class2 is smaller than a preset amount, the processor 110 may redefine a class of the first-1 cluster data Cluster1-1 from the first class to the second class.

In an embodiment, when a difference in amount between the first class data Class1 and the second class data Class2 is greater than a preset amount, such that data imbalance between the first class data Class1 and the second class data Class2 is severe, the processor 110 may process class overlap by changing a class of the first-1 cluster data Cluster1-1.

In an embodiment, after redefining a class of the first-1 cluster data Cluster1-1 into the second class, the processor 110 may reconstruct the learning dataset. In an embodiment, when a class of the first-1 cluster data Cluster1-1 is redefined into the second class, the first class data Class1 may include the first-2 cluster data Cluster1-2 and the first-3 cluster data Cluster1-3. In an embodiment, when a class of the first-1 cluster data Cluster1-1 is redefined into the second class, the second class data Class2 may include the first-1 cluster data Cluster1-1, the second-1 cluster data Cluster2-1, the second-2 cluster data Cluster2-2, and the second-3 cluster data Cluster2-3.

In an embodiment, the processor 110 may control the artificial intelligence model 120 to retrain based on the first-2 cluster data Cluster1-2 and the first-3 cluster data Cluster1-3, which correspond to remaining cluster data of the first class data Class1 excluding the first-1 cluster data Cluster1-1, and the second class data Class2 including the first-1 cluster data Cluster1-1.

In an embodiment, the artificial intelligence model 120 may determine a third decision boundary that distinguishes the first-2 cluster data Cluster1-2 and the first-3 cluster data Cluster1-3 corresponding to remaining cluster data and the second class data Class2 including the first-1 cluster data Cluster1-1 as a decision boundary.

In an embodiment, when first data Data1 and second data Data2 are received as input data, the artificial intelligence model 120 retrained based on the first-2 cluster data Cluster1-2 and the first-3 cluster data Cluster1-3 and the second class data Class2 including the first-1 cluster data Cluster1-1 may classify the first data Data1 and the second data Data2 according to the third decision boundary. In an embodiment, the first data Data1 may be data indicating a normal state of an industrial facility or a health state of a human, and the second data Data2 may be data indicating a defect state of an industrial facility or a disease state of a human.

In an embodiment, the retrained artificial intelligence model 120 may classify the second data Data2 into the second class according to the third decision boundary. In an embodiment, the retrained artificial intelligence model 120 may have higher sensitivity than the artificial intelligence model trained based on the learning data by classifying the second data Data2 corresponding to data indicating a defect state of an industrial facility or a disease state of a human into the second class data Class2 according to the third decision boundary, instead of classifying it into the first class data Class1 indicating a normal state or a health state.

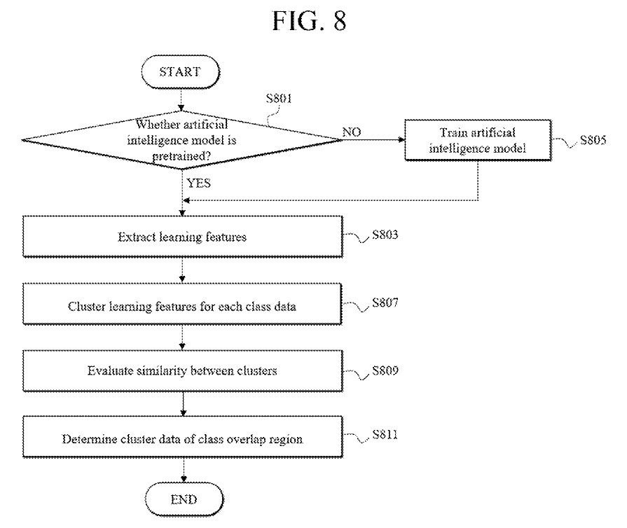

FIG. 8 is a flowchart illustrating a computing device for determining cluster data of a class overlap region according to an embodiment.

Referring to FIG. 8, at operation S801, the computing device 100 may determine whether the artificial intelligence model 120 is a pretrained model. In an embodiment, when the artificial intelligence model 120 is a pretrained model, operation S803 may be performed. In an embodiment, when the artificial intelligence model 120 is not a pretrained model, operation S805 may be performed.

At operation S803, when the artificial intelligence model 120 is a pretrained model, the computing device 100 may extract learning features from the artificial intelligence model 120. In an embodiment, the computing device 100 may extract flattened data output from a flattening layer as learning feature data.

At operation S805, when the artificial intelligence model 120 is not a trained model, the computing device 100 may train the artificial intelligence model based on learning data.

At operation S807, the computing device 100 may cluster learning features for each class data. In an embodiment, the computing device 100 may classify the learning feature data into a plurality of cluster data based on a result of clustering the learning feature data.

At operation S809, the computing device 100 may evaluate similarity between clusters. In an embodiment, the computing device 100 may determine values representing similarity between the plurality of cluster data using a silhouette coefficient.

At operation S811, the computing device 100 may determine cluster data of a class overlap region. In an embodiment, the computing device 100 may determine cluster data associated with the smallest value among values representing similarity between the plurality of cluster data as cluster data of the class overlap region.

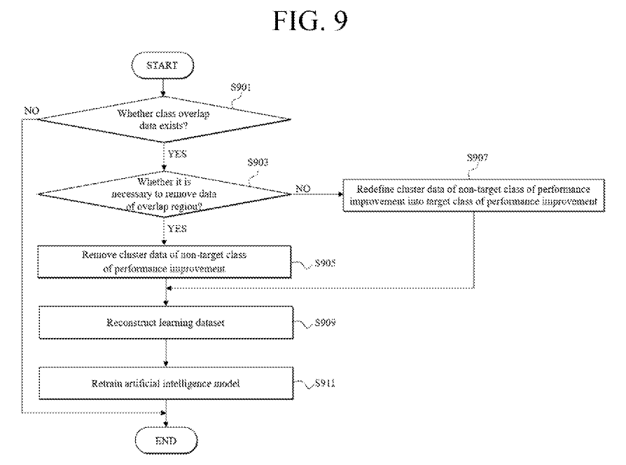

FIG. 9 is a flowchart illustrating a computing device for readjusting cluster data of a class overlap region according to an embodiment.

Referring to FIG. 9, at operation S901, the computing device 100 may determine whether class overlap data exists. In an embodiment, when a smallest value among values representing similarity between the plurality of cluster data is smaller than a threshold, the computing device 100 may determine that class overlap data exists. In an embodiment, when class overlap data exists, operation S903 may be executed. In an embodiment, when the class overlap data does not exist, the process may end.

At operation S903, the computing device 100 may determine whether it is necessary to remove data of an overlap region. In an embodiment, whether it is necessary to remove data of the overlap region may be determined based on an amount of second class data corresponding to a small number data among first class data and second class data. In an embodiment, whether it is necessary to remove data of the overlap region may be determined based on the difference in amount between the first class data and the second class data. In an embodiment, when it is necessary to remove data of the overlap region, operation S905 may be performed. In an embodiment, when it is not necessary to remove data of the overlap region, operation S907 may be performed.

At operation S905, when it is necessary to remove data of the overlap region, the computing device 100 may remove cluster data of a non-target class of performance improvement. In an embodiment, the non-target class of performance improvement may be a class indicating a normal state of an industrial facility or a health state of a human. In an embodiment, the computing device 100 may exclude cluster data of the overlap region of the non-target class of performance improvement from the learning data.

At operation S907, when it is not necessary to remove data of an overlap region, the computing device 100 may redefine cluster data of the non-target class of performance improvement into a target class of performance improvement. In an embodiment, the target class of performance improvement may be a class indicating a defect state of an industrial facility or a disease state of a human.

At operation S909, the computing device 100 may reconstruct a learning dataset. In an embodiment, the computing device 100 may reconstruct the learning dataset based on the learning data excluding cluster data of an overlap region of the non-target class of performance improvement. In an embodiment, the computing device 100 may reconstruct the learning dataset based on cluster data of the non-target class of performance improvement redefined into the target class of performance improvement.

At operation S911, the computing device 100 may retrain the artificial intelligence model based on the reconstructed learning dataset.

While embodiments of the present disclosure have been described in detail above, the scope of the present disclosure is not limited thereto, and various modifications and improvements made by those skilled in the art using the basic concept defined in the following claims also fall within the scope of the present disclosure.

### DESCRIPTION OF REFERENCE NUMERALS

100: computing device

110: processor

120: artificial intelligence model

130: memory

140: input interface

What is claimed is:

1. A method of training an artificial intelligence model of a computing device, comprising:
training an artificial intelligence model on learning data;
extracting flattened data output from a flattening layer of the artificial intelligence model as learning feature data;
classifying the learning feature data into a plurality of cluster data based on a result of clustering the learning feature data;
determining first cluster data of first class data and second cluster data of second class data, the first cluster data and the second cluster data including data of a class overlap region, based on a result of quantifying similarity between the plurality of cluster data;
processing the class overlap on the first cluster data based on an amount of the second class data; and
retraining the artificial intelligence model.

2. The method of claim 1, wherein processing a class overlap includes removing the first cluster data from the learning data when the amount of the second class data is greater than a preset amount.

3. The method of claim 2, wherein retraining the artificial intelligence model includes retraining the artificial intelligence model based on remaining cluster data of the first class data excluding the first cluster data and the second class data.

4. The method of claim 3, the method includes, after retraining the artificial intelligence model, determining a boundary that distinguishes the remaining cluster data and the second class data as a decision boundary.

5. The method of claim 1, wherein processing a class overlap includes redefining a class of the first cluster data from the first class to the second class when the amount of the second class data is smaller than a preset amount.

6. The method of claim 5, wherein retraining the artificial intelligence model includes retraining the artificial intelligence model based on remaining cluster data of the first class data excluding the first cluster data and the second class data including the first cluster data.

7. The method of claim 6, after retraining the artificial intelligence model, the method includes determining a boundary that distinguishes the remaining cluster data and the second class data including the first cluster data as a decision boundary.

8. The method of claim 1, wherein the learning data is data related to an industrial facility,
the first class data is data indicating that the industrial facility is in a normal state, and
the second class data is data indicating that the industrial facility is in a fault state.

9. The method of claim 1, wherein the learning data is data related to human health,
the first class data is data indicating a health state, and
the second class data is data indicating a disease state.

10. A computing device comprising:
an artificial intelligence model configured to be trained based on learning data; and
a processor configured to:
extract flattened data output from a flattening layer of the artificial intelligence model as learning feature data;
classify the learning feature data into a plurality of cluster data based on a result of clustering the learning feature data;
determine first cluster data of first class data and second cluster data of second class data, the first cluster data and the second cluster data including data of a class overlap region, based on a result of quantifying similarity between the plurality of cluster data;
process the class overlap on the first cluster data based on an amount of the second class data; and
retrain the artificial intelligence model based on a result of processing the class overlap.

11. The computing device of claim 10, wherein the processor is configured to control the artificial intelligence model to retrain based on remaining cluster data of the first class data excluding the first cluster data and the second class data when a difference in amount between the first class data and the second class data is smaller than a preset amount.

12. The computing device of claim 11, wherein the processor is configured to assign the first cluster data from the first class data to the second class data when a difference in amount between the first class data and the second class data is greater than a preset amount.

13. The computing device of claim 12, wherein the processor is configured to control the artificial intelligence model to retrain the artificial intelligence model based on the remaining cluster data and the second class data including the first cluster data.

14. The computing device of claim 13, wherein a sensitivity of the artificial intelligence model retrained based on the remaining cluster data and the second class data including the first cluster data is higher than a sensitivity of the artificial intelligence model learned based on the learning data.

15. The computing device of claim 14, wherein the artificial intelligence model trained based on the learning data determines a boundary that distinguishes the first cluster data and the second cluster data as a decision boundary, and the retrained artificial intelligence model determines a boundary that distinguishes the remaining cluster data and the second class data including the first cluster data as a decision boundary.
